(19) United States
(12) Patent Application Publication
(10) Pub. No.: US 2012/0182394 A1
(43) Pub. Date: Jul. 19, 2012

(54) 3D IMAGE SIGNAL PROCESSING METHOD FOR REMOVING PIXEL NOISE FROM DEPTH INFORMATION AND 3D IMAGE SIGNAL PROCESSOR THEREFOR

(75) Inventors: KWANG HYUK BAE, SEOUL (KR); TAE CHAN KIM, YONGIN-SI (KR); KYU-MIN KYUNG, SEOUL (KR)

(73) Assignee: SAMSUNG ELECTRONICS CO., LTD., SUWON-SI (KR)

(21) Appl. No.: 13/353,407

(22) Filed: Jan. 19, 2012

(30) Foreign Application Priority Data
Jan. 19, 2011 (KR) 10-2011-0005623

(51) Int. Cl. H04N 13/02

(52) U.S. Cl. 348/46; 348/E13.074

(57) ABSTRACT

A three-dimensional (3D) image signal processing method increases signal-to-noise ratio by performing pixel binning on depth information obtained by a 3D image sensor, without changing a filter array detecting the depth information. The processing method may be used in a 3D image signal processor, and a 3D image processing system including the 3D image signal processor.

### CROSS-REFERENCE TO RELATED APPLICATIONS

A claim for priority under 35 U.S.C. §119(a) is made to Korean Patent Application No. 10-2011-0005623 filed on Jan. 19, 2011, the entirety of which is incorporated herein by reference.

### BACKGROUND

The inventive concepts herein relate to a signal processing method and device, and more particularly, to a three-dimensional (3D) image signal processing method and a 3D image signal processor.

Recently, portable devices (e.g., digital cameras, mobile communication terminals, and table personal computers (PCs)) equipped with an image sensor have been developed and sold in market.

In order to acquire a 3D image using an image sensor, it is necessary to obtain information about a distance between an object and the image sensor as well as color information. An image reconstructed based on the information about the distance between the object and the image sensor is generally referred to as a depth image. In general, a depth image can be obtained using visible light and infrared light. A color filter array used in an image sensor includes a color filter which passes a particular wavelength of the visible light in order to detect color image information of an object, and an infrared filter which passes a particular wavelength in order to detect depth information of the object.

A pixel for detecting the depth information has lower sensitivity than a pixel for detecting the color information, and thus has a low signal-to-noise ratio. Therefore, a color filter array, an infrared filter array, and an image sensor including such arrays require a special algorithm for increasing the signal-to-noise ratio of the depth information.

### SUMMARY

According to some embodiments of the inventive concepts, there is provided a three-dimensional (3D) image signal processing method including generating a first image based on color information and depth information obtained by a 3D image sensor; obtaining a binning value by performing binning using a particular pixel among pixels for the depth information of the first image and pixels for the depth information that are adjacent the particular pixel; and updating the depth information with the binning value and generating a second image by matching updated depth information with the color information.

The operation of generating the first image may include separating the pixels for the depth information from pixels for the color information, and storing the pixels for the depth information.

The operation of obtaining the binning value may include selecting the particular pixel from the pixels for the depth information of the first image and obtaining an average value using pixel values of the particular pixel and the adjacent pixels; the operation of updating the depth information including updating the pixel value of the particular pixel with the average value, and updating the depth information with respect to an entirety of the first image.

The operation of selecting the particular pixel and obtaining the average value may include selecting the particular pixel from the pixels for the depth information of the first image, deciding a weight for each of the particular pixel and the adjacent pixels, and obtaining a weighted average using pixel values of the weighted pixels.

The operation of obtaining the binning value may further include controlling the binning based on a value of the depth information of the first image.

According to other embodiments of the inventive concepts, there is provided a 3D image signal processor including a first image generator configured to generate a first image based on color information and depth information obtained by a 3D image sensor; and a pixel binning unit configured to perform binning using a particular pixel among pixels for the depth information of the first image and pixels for the depth information that are adjacent the particular pixel.

The 3D image signal processor may further include a depth buffer configured to separate the pixels for the depth information from pixels for the color information, and store the pixels for the depth information.

The pixel binning unit may include a calculator configured to select the particular pixel of the first image from the depth buffer and calculate an average value using pixel values of the particular pixel and the adjacent pixels; an updating block configured to update the pixel value of the particular pixel with the average value and update the depth information with respect to an entirety of the first image; and a matching block configured to generate a second image by matching updated depth information with the color information.

The calculator may decide a weight for each of the particular pixel and the adjacent pixels, apply the weight to each of the pixels, and calculate a weighted average.

The 3D image signal processor may further include a controller configured to generate a control signal based on a value of the depth information of the first image to control an operation of the pixel binning unit.

### BRIEF DESCRIPTION OF THE DRAWINGS

The above and other features and advantages of the inventive concepts will become more apparent from the following description with reference to the following figures, in which:

FIG. 1 is a block diagram of a three-dimensional (3D) image processing system including a 3D image signal processor according to some embodiments of the inventive concepts;

FIG. 2 is a flowchart of a 3D image signal processing method according to some embodiments of the inventive concepts;

FIG. 3 is a flowchart of a 3D image signal processing method according to other embodiments of the inventive concepts;

FIGS. 4A through 4E are diagrams showing the patterns of a pixel array explanatory of pixel binning according to some embodiments of the inventive concepts;

FIG. 5 is a block diagram of the 3D image signal processor according to some embodiments of the inventive concepts; and

FIG. 6 is a schematic block diagram of an electronic system including a 3D image signal processor according to some embodiments of the inventive concepts.

### DETAILED DESCRIPTION

The inventive concepts will be described more fully hereinafter with reference to the accompanying figures, in which embodiments of the inventive concepts are shown. However, the inventive concepts may be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, such elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the inventive concepts belong. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

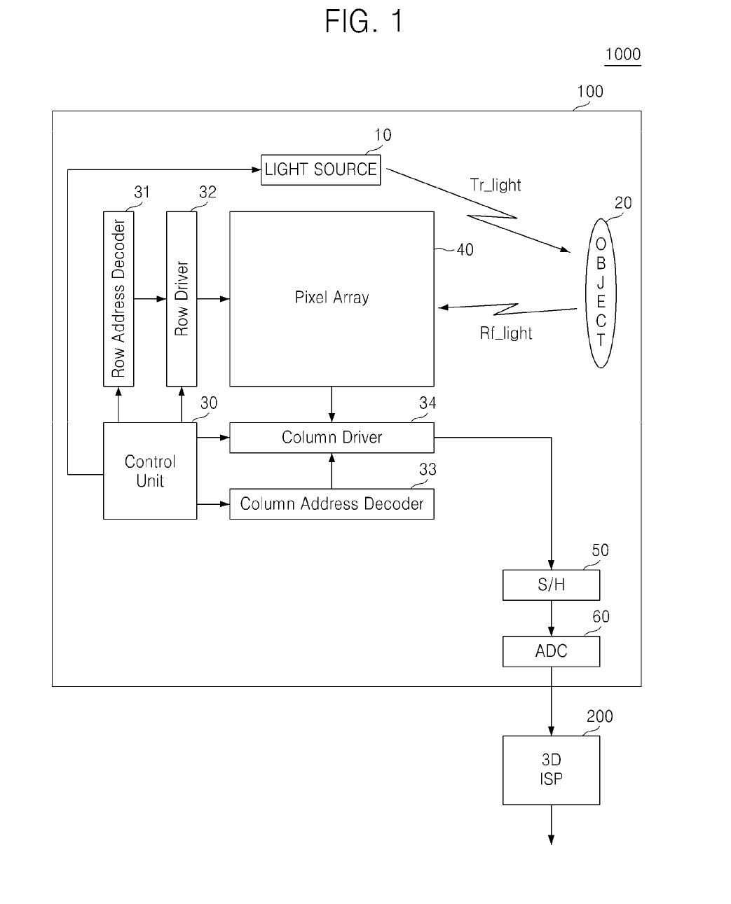

FIG. 1 is a block diagram of a three-dimensional (3D) image processing system including a 3D image signal processor (ISP), according to some embodiments of the inventive concepts.

The 3D image processing system 1000 includes a 3D image sensor 100 and the 3D ISP 200. The 3D image sensor 100 includes a light source 10, a control unit 30, a row address decoder 31, a row driver 32, a column address decoder 33, a column driver 34, a pixel array 40, a sample and hold (S/H) block 50, and an analog-to-digital converter (ADC) 60.

The control unit 30 may output a plurality of control signals to control the operations of the light source 10, the pixel array 40, the row address decoder 31, the row driver 32, the column address decoder 33, the column driver 34, the S/H block 50, the ADC 60, and the 3D ISP 200, and may generate address signals for the output of a signal (including a color image signal and a depth image signal) detected in the pixel array 40.

In detail, the control unit 30 may control the row address decoder 31 and the row driver 32 to select a row line connected with a pixel among a plurality of pixels in the pixel array 40, so that a signal detected by the pixel is output. The control unit 30 may also control the column address decoder 33 and the column driver 34 to select a column line connected with the pixel. In addition, the control unit 30 may control the light source 10 to emit light periodically and may control on/off timing of photo-detecting devices for sensing a distance among the pixels in the pixel array 40.

The row address decoder 31 decodes a row control signal received from the control unit 30 and outputs a decoded row control signal. The row driver 32 selectively activates a row line in the pixel array 40 in response to the decoded row control signal received from the row address decoder 31.

The column address decoder 33 decodes a column control signal (e.g., an address signal) received from the control unit 30 and outputs a decoded column control signal. The column driver 34 selectively activates a column line in the pixel array 40 in response to the decoded column control signal received from the column address decoder 33.

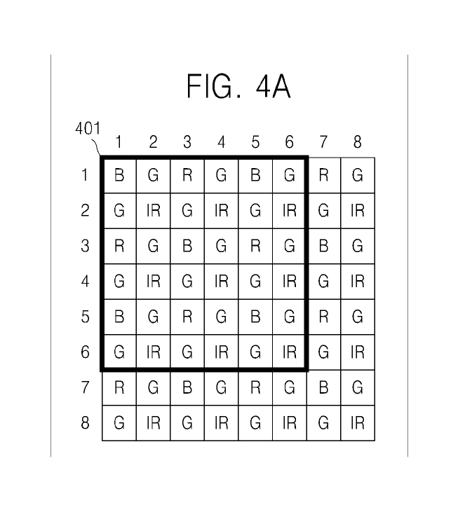

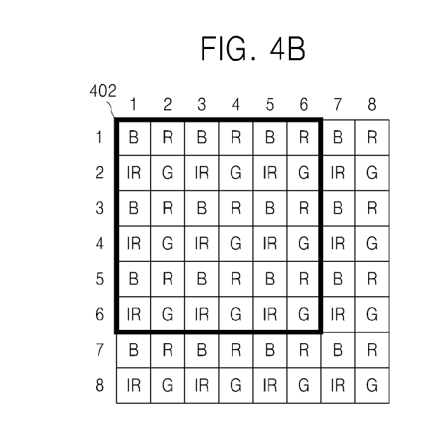

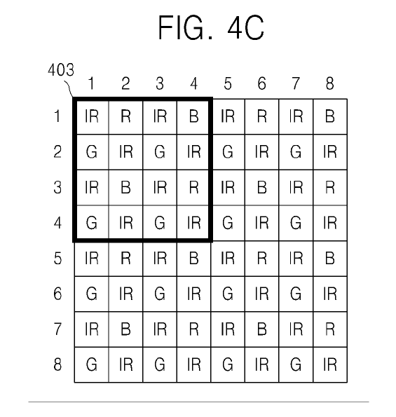

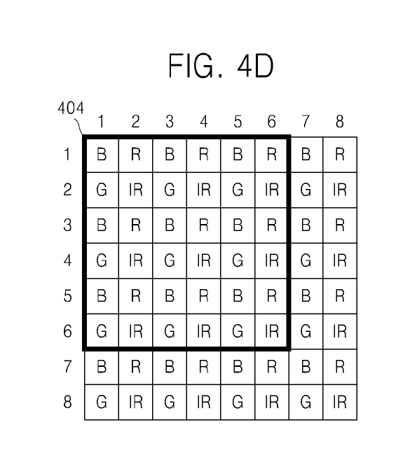

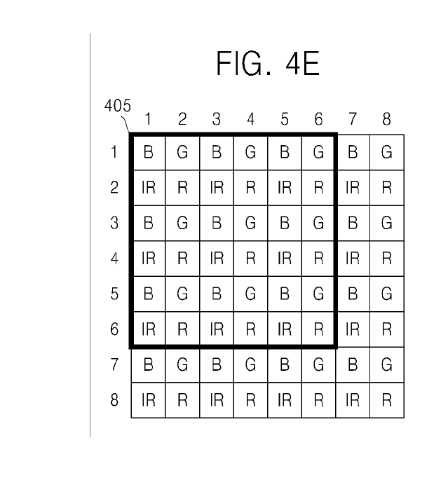

The pixel array 40 may include a plurality of pixel arrays illustrated in FIGS. 4A through 4E. However, it is apparent that the pixel array 40 may include an array in which color pixels (such as magenta (Mg), cyan (Cy), yellow (Y), black (B), and white (W)) in addition to RGB color pixels illustrated in FIGS. 4A through 4E are arranged.

Each of the pixels in the pixel array 40 may output pixel signals (e.g., a color image signal and a depth image signal) in unit of columns in response to a plurality of control signals generated by the row driver 32.

The S/H block 50 may sample and hold pixel signals output from a pixel selected by the row driver 32 and the column driver 34. In other words, the S/H block 50 may sample and hold pixel signals output from a pixel selected by the row driver 32 and the column driver 34 among the pixels in the pixel array 40.

The ADC 60 may perform analog-to-digital conversion on signals output from the S/H block 50 and output digital pixel data. At this time, the S/H block 50 and the ADC 60 may be implemented in a single chip.

The ADC 60 may include a correlated double sampling (CDS) circuit (not shown) which performs CDS on signals output from the S/H block 50 and outputs a CDS signal as a CDS result. The ADC 60 may compare the CDS signal with a ramp signal (not shown) and output a comparison result as the digital pixel data.

The 3D ISP 200 may perform digital image processing based on pixel data output from the ADC 60. The 3D ISP 200 may perform interpolation on 3D image signals having different formats such as color (e.g., red (R), green (G), and blue (B)) and distance (D) and generate a 3D image using interpolated signals. The 3D ISP 200 may receive a signal generated by a photo-detecting device, sense light flight time based on the signal, and calculate a distance. In addition, the 3D ISP 200 may perform functions such as edge enhancement and suppression of spurious color components.

Hereinafter, procedures in which the 3D ISP 200 processes depth information will be described. Color information and depth information may be generated by a filter array, but the inventive concepts are not limited thereto.

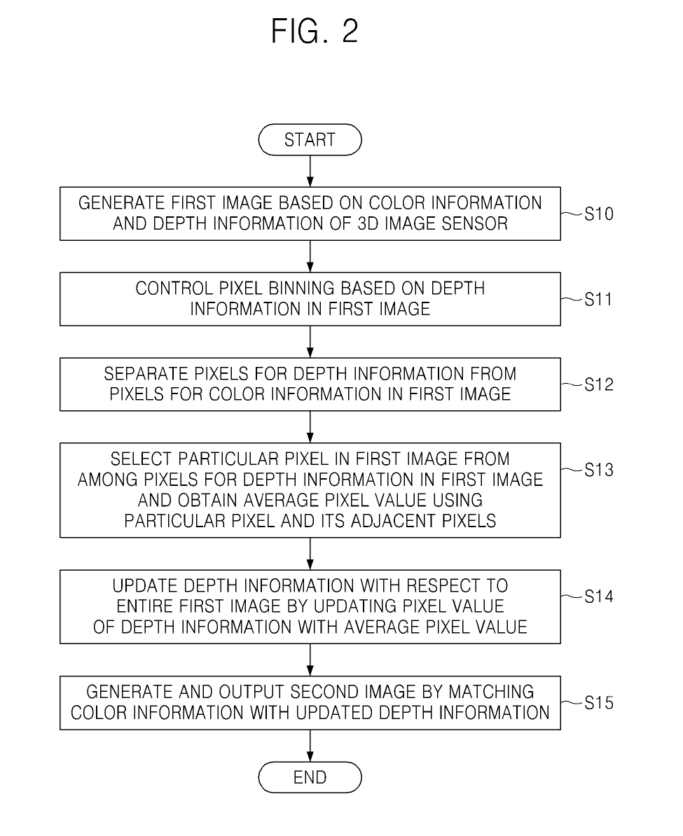

FIG. 2 is a flowchart of a 3D image signal processing method according to some embodiments of the inventive concepts.

Referring to FIGS. 1 and 2, when the light source 10 emits light Tr_light to an object 20, the pixel array 40 of the 3D image sensor 100 receives color information from visible light and depth information from reflected light Rf_light. In other words, the pixel array 40 generates a signal by converting photons into electrons using a photo-detecting device and calculates 3D image information based on the signal.

The color information may be usually obtained using a red filter, a green filter, and a blue filter in a visible spectrum. However, the red filter may be replaced with one of a cyan filter, a yellow filter, and a magenta filter, the green filter may be replaced with another one of them, and the blue filter may be replaced with the other of them. The embodiments of the inventive concepts use an RGB pixel array using red, green and blue filters, but the inventive concepts are not limited to such color filters. The 3D image sensor 100 may use infrared light or light, such as green light, having a particular frequency/wavelength to obtain a depth image. The depth image may be obtained using a direct or an indirect method. At this time, the 3D image sensor 100 may be implemented using a pinned photodiode or other types of photodiodes.

For clarity of the description, it is assumed that infrared light is used to calculate depth information in the embodiments described here, but the inventive concepts are not limited to those embodiments.

In general, the sensitivity of a pixel storing depth information is lower than that of a pixel storing color information. Accordingly, the depth information is less in quantity and has a larger noise than the color information. When pixel binning is performed according to some embodiments of the inventive concepts, the sensitivity of the depth information of a 3D image signal is increased.

Referring to FIG. 2, a first image is generated based on color information and depth information obtained by the 3D image sensor 100 in operation S10. At this time, the first image may be an image in which color information and depth information stored in the pixel array 40 are maintained as they are, or an image obtained after predetermined image signal processing such as interpolation has been performed. Pixel binning may be controlled based on the sensitivity of the depth information of the first image in operation S11. When the pixel binning is needed to be performed, pixels for the depth information of the first image are separated from pixels for the color information in operation S12. Here, “binning” is a process of accumulating or interpolating charges of a plurality of pixels and reading them in a single operation. The depth information may be subjected to image signal processing and then matched with the color information, so that a second image is generated. In order to perform the pixel binning, a particular pixel is selected from among the pixels for the depth information in the first image and an average pixel value is obtained using the particular pixel and its adjacent pixels in operation S13. The pixel binning is expressed by Equation 1:

$$\overline{IR} = \frac{1}{n} {\sum }_{i = 1}^{n} {IR}_{i} \qquad ( 1 )$$

where IRᵢ is a pixel value of the depth information in the first image, “n” is the number of pixels used in the method to perform the pixel binning, and I̅R̅ is a pixel value of updated depth information obtained after the pixel binning. The pixel binning involving Equation 1 will be described in detail with reference to FIGS. 4A through 4E later.

The operation of obtaining the average pixel value may be performed on only part of the first image. In this case, the operation is repeated until the depth information is updated with respect to the entire first image in operation S14. The updated depth information is matched with the color information that has been separated from the depth information so that an updated image, i.e., the second image is generated and output in operation S15.

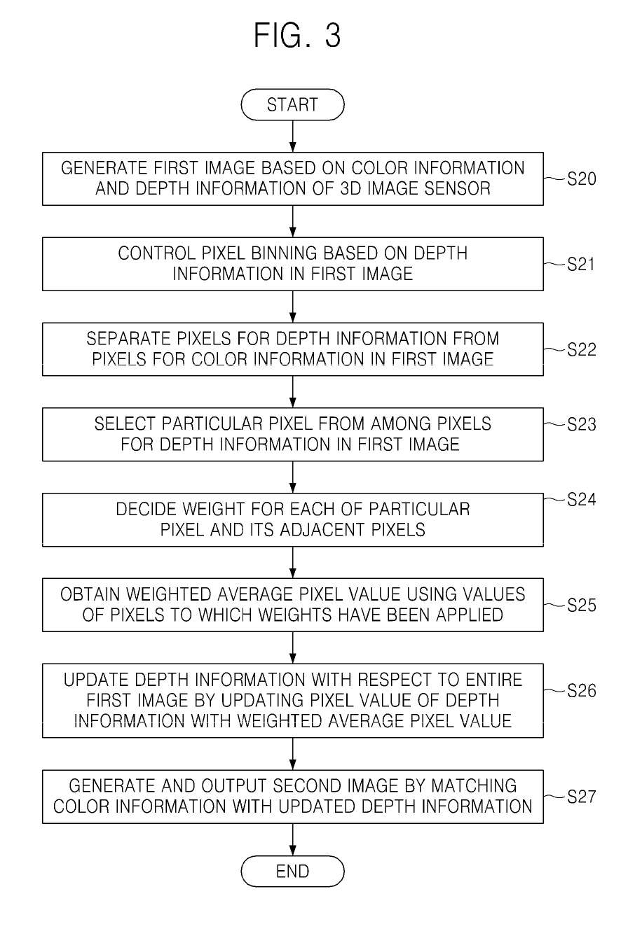

FIG. 3 is a flowchart of a 3D image signal processing method according to other embodiments of the inventive concepts.

Referring to FIGS. 1 and 3, when the light source 10 emits light Tr_light to the object 20, the pixel array 40 of the 3D image sensor 100 receives depth information from reflected light Rf_light. The pixel array 40 also generates a signal by converting photons into electrons using a photo-detecting device and calculates color information based on the signal.

The color information may be usually obtained using a red filter, a green filter, and a blue filter in a visible spectrum. However, the red filter may be replaced with one of a cyan filter, a yellow filter, and a magenta filter, the green filter may be replaced with another one of them, and the blue filter may be replaced with the other of them. The embodiments of the inventive concepts use an RGB pixel array using red, green and blue filters, but the inventive concepts are not limited to such color filters. The 3D image sensor 100 may use infrared light or light, such as green light, having a particular frequency/wavelength to obtain a depth image. The depth image may be obtained using a direct or an indirect method. At this time, the 3D image sensor 100 may be implemented using a pinned photodiode or other types of photodiodes.

For clarity of the description, it is assumed that infrared light is used to calculate depth information in the embodiments described here, but the inventive concepts are not limited to those embodiments.

Referring to FIG. 3, a first image is generated based on color information and depth information obtained by the 3D image sensor 100 in operation S20. At this time, the first image may be an image in which color information and depth information stored in the pixel array 40 are maintained as they are, or an image obtained after predetermined image signal processing such as interpolation has been performed. Pixel binning may be controlled based on the sensitivity of the depth information of the first image in operation S21. When the pixel binning is needed to be performed, pixels for the depth information of the first image are separated from pixels for the color information in operation S22. The depth information may be subjected to image signal processing and then matched with the color information, so that a second image is generated. In order to perform the pixel binning, a particular pixel is selected from among the pixels for the depth information in the first image in operation S23, and a weight applied to each of the pixels and the adjacent pixels are decided in operation S24. At this time, the weight is a pixel binning gain. A weight for a part of the depth information having lower sensitivity in the first image is different from a weight for a part of the depth information having higher sensitivity in the first image, so that the sensitivity of the entire depth information is increased. After the weight is decided in operation S24, a weighted average pixel value for the particular pixel is obtained using values of the pixels to which the weights have been applied in operation S25. The pixel binning is expressed by Equation 2:

$$\overline{IR} = \frac{1}{n} {\sum }_{i = 1}^{n} ( {w}_{i} \cdot {IR}_{i} ) \qquad ( 2 )$$

where IRᵢ is a pixel value of the depth information in the first image, “n” is the number of pixels used in the method to perform the pixel binning, I̅R̅ is a pixel value of updated depth information obtained after the pixel binning, and wᵢ is a weight applied to each of the pixels used in the pixel binning.

The operation of obtaining the weighted average pixel value may be performed on only part of the first image. In this case, the operation is repeated until the depth information is updated with respect to the entire first image in operation S26. The updated depth information is matched with the color information that has been separated from the depth information so that an updated image, i.e., the second image is generated and output in operation S27.

FIGS. 4A through 4E are diagrams showing the patterns of a pixel array explanatory of pixel binning according to some embodiments of the inventive concepts.

Depth pixels for detecting depth information and pixels for detecting image information may be implemented in a single pixel array in the 3D image sensor 100.

Referring to FIGS. 4A through 4E, pixels used to perform the pixel binning may be combined in various patterns and B, G, and R pixels for color information and infrared (IR) pixels for depth information are regularly arranged in the pixel array 40 of the 3D image sensor 100. An IR pixel for detecting depth information of an object has lower sensitivity than a pixel for detecting color information of the object. The low sensitivity of the IR pixel causes noise to occur. To increase the sensitivity of the IR pixel for the depth information, the pixel binning is performed.

FIG. 4A is a diagram for explaining a method of obtaining an updated pixel value of a pixel IR_{4,4} when IR pixels are subjected to 3×3 pixel binning 401 according to some embodiments of the inventive concepts. The updated pixel value of the pixel IR_{4,4} obtained after the pixel binning may be obtained by calculating the sum of the pixel values of pixels IR_{2,2}, IR_{4,2}, IR_{2,4}, IR_{4,4}, IR_{6,4}, and IR_{6,6} and dividing the sum by the number of the pixels used for the pixel binning, i.e., 9, which is expressed by Equation 3:

$$\overline{{IR}_{4 , 4}} = \frac{\begin{matrix}{IR}_{2 , 2} + {IR}_{2 , 4} + {IR}_{2 , 6} + {IR}_{4 , 2} + \\ {IR}_{4 , 4} + {IR}_{4 , 6} + {IR}_{6 , 2} + {IR}_{6 , 4} + {IR}_{6 , 6}\end{matrix}}{9} . \qquad ( 3 )$$

FIG. 4B is a diagram for explaining a method of obtaining an updated pixel value of a pixel IR_{3,4} when IR pixels are subjected to 3×3 pixel binning 402 according to some embodiments of the inventive concepts. The updated pixel value of the pixel IR_{3,4} obtained after the pixel binning may be obtained using the same method as shown in FIG. 4A, which is expressed by Equation 4:

$$\overline{{IR}_{3 , 4}} = \frac{\begin{matrix}{IR}_{1 , 2} + {IR}_{3 , 2} + {IR}_{5 , 2} + {IR}_{1 , 4} + \\ {IR}_{3 , 4} + {IR}_{5 , 4} + {IR}_{1 , 6} + {IR}_{3 , 6} + {IR}_{5 , 6}\end{matrix}}{9} . \qquad ( 4 )$$

FIG. 4C is a diagram for explaining a method of obtaining an updated pixel value of a pixel IR_{2,2} when IR pixels are subjected to 3×3 pixel binning 403 according to some embodiments of the inventive concepts. The updated pixel value of the pixel IR_{2,2} obtained after the pixel binning may be obtained using the same method as shown in FIG. 4A, which is expressed by Equation 5:

$$\overline{{IR}_{2 , 2}} = \frac{{IR}_{1 , 1} + {IR}_{3 , 1} + {IR}_{2 , 2} + {IR}_{1 , 3} + {IR}_{3 , 3}}{5} . \qquad ( 5 )$$

FIG. 4D is a diagram for explaining a method of obtaining an updated pixel value of a pixel IR_{4,4} when IR pixels are subjected to 6×6 pixel binning 404 according to some embodiments of the inventive concepts. The updated pixel value of the pixel IR_{4,4} obtained after the pixel binning may be obtained using the same method as shown in FIG. 4A, which is expressed by Equation 6:

$$\overline{{IR}_{4 , 4}} = \frac{\begin{matrix}{IR}_{2 , 2} + {IR}_{2 , 4} + {IR}_{2 , 6} + {IR}_{4 , 2} + \\ {IR}_{4 , 4} + {IR}_{4 , 6} + {IR}_{6 , 2} + {IR}_{6 , 4} + {IR}_{6 , 6}\end{matrix}}{9} . \qquad ( 6 )$$

FIG. 4E is a diagram for explaining a method of obtaining an updated pixel value of a pixel IR_{3,4} when IR pixels are subjected to 6×6 pixel binning 405 according to some embodiments of the inventive concepts. The updated pixel value of the pixel IR_{3,4} obtained after the pixel binning may be obtained using the same method as shown in FIG. 4A, which is expressed by Equation 7:

$$\overline{{IR}_{3 , 4}} = \frac{\begin{matrix}{IR}_{1 , 2} + {IR}_{3 , 2} + {IR}_{5 , 2} + {IR}_{1 , 4} + \\ {IR}_{3 , 4} + {IR}_{5 , 4} + {IR}_{1 , 6} + {IR}_{3 , 6} + {IR}_{5 , 6}\end{matrix}}{9} . \qquad ( 7 )$$

In other words, even with respect to pixel arrays in different patterns as shown in FIGS. 4A through 4E, the same method is used to obtain an updated IR pixel value using pixel binning.

Accordingly, the pixel binning is expressed by Equation 1. When different weights are used depending on the sensitivity of an IR pixel, pixel binning expressed by Equation 2 is performed. When the pixel binning is performed, the second image with higher sensitivity of depth information than the first image is generated. In other words, an image with depth information having reduced noise is generated by using pixel binning without changing a filter array.

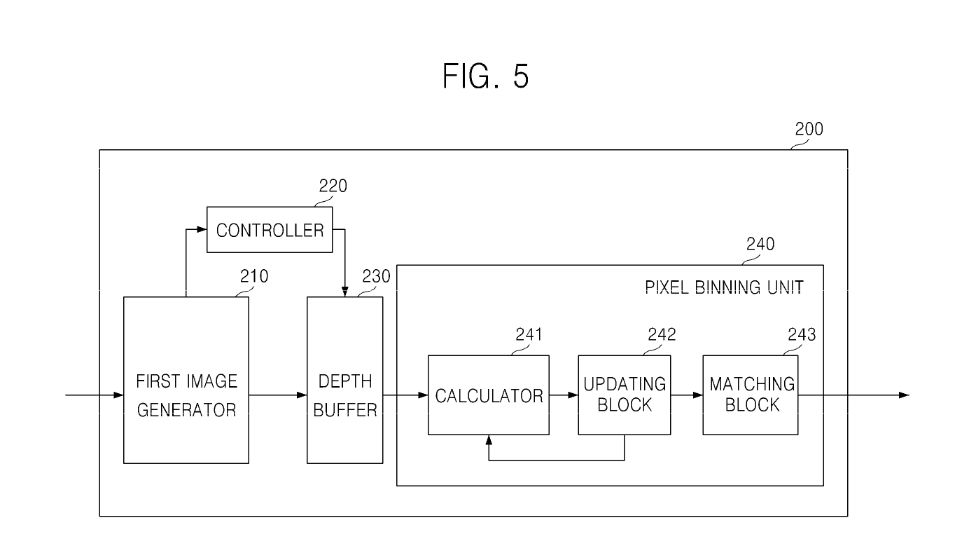

FIG. 5 is a block diagram of the 3D ISP 200 according to some embodiments of the inventive concepts.

The 3D ISP 200 includes a first image generator 210 and a pixel binning unit 240. The 3D ISP 200 may directly extract depth information of a first image from the pixel array 40 and use the depth information to generate depth information of a second image. However, in the embodiments illustrated in FIG. 5, the 3D ISP 200 may include a depth buffer 230 which stores depth information separated from color information in order to process depth information in different patterns at a time.

The first image generator 210 generates a first image based on color information and depth information received from the 3D image sensor 100. At this time, the first image may be an image in which color information and depth information stored in the pixel array 40 are maintained as they are, or an image obtained after predetermined image signal processing such as interpolation has been performed.

The depth buffer 230 separates pixels for the depth information from pixels for the color information in the first image generated by the first image generator 210 and stores the pixels for the depth information.

The pixel binning unit 240 selects a pixel from among the pixels for the depth information of the first image, which are stored in the depth buffer 230, performs pixel binning using the pixel and its adjacent pixels, and generates and outputs a second image. The pixel binning unit 240 includes a calculator 241, an updating block 242, and a matching block 243.

The calculator 241 performs pixel binning by calculating an average pixel value using the pixel and the adjacent pixels for the depth information of the first image. The updating block 242 update a pixel value of the depth information with the average pixel value to update the entire depth information of the first image. The matching block 243 matches the color information of the first image with the updated depth information, and generates and outputs the second image.

In the pixel binning performed by the calculator 241, an arithmetical mean (i.e., Equation 1) may be calculated using a particular pixel and its adjacent pixels to update depth information.

Alternatively, in the pixel binning performed by the calculator 241, a weighted average (i.e., Equation 2 in which different weights are applied to pixels) may be calculated using a particular pixel and its adjacent pixels to update depth information so that the sensitivity of the depth information is increased with respect to an entire 3D image.

The 3D ISP 200 may also include a controller 220. The controller 220 analyzes the depth information of the first image output from the first image generator 210 and controls the execution of pixel binning.

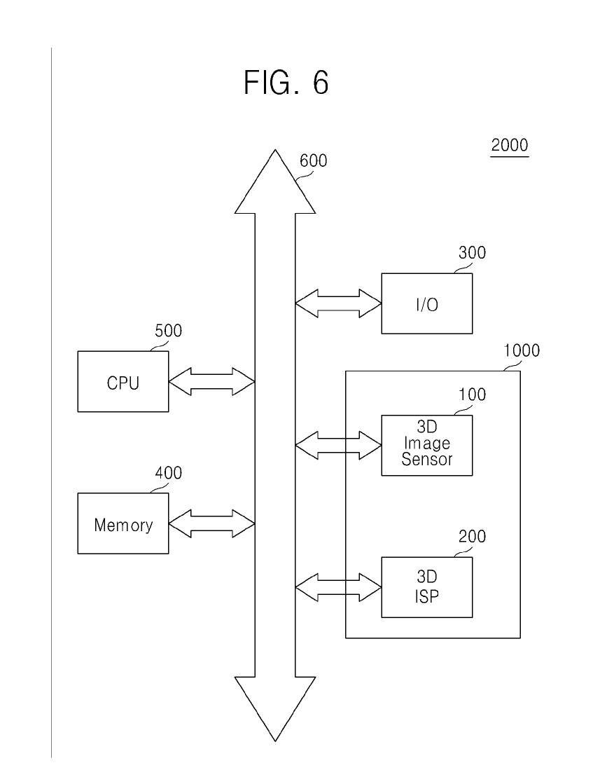

FIG. 6 is a schematic block diagram of an electronic system 2000 including the 3D ISP 200 according to some embodiments of the inventive concepts.

The 3D image processing system 1000 includes the 3D image sensor 100 and the 3D ISP 200. The 3D image sensor 100 may be implemented using complementary metal oxide semiconductor (CMOS) or a charge coupled device (CCD).

The 3D image processing system 1000 may be included in the electronic system 2000 that uses 3D images. The electronic system 2000 may be a digital camera, a mobile phone equipped with a digital camera, or any electronic system equipped with a digital camera. The electronic system 2000 may include a processor or a central processing unit (CPU) 500 controlling the operation of the 3D image processing system 1000. The electronic system 2000 may also include an interface. The interface may be an image display device or an input/output (I/O) device 300.

The image display device may include a memory device 400 which is controlled by the processor 500 to store a still or a moving image captured by the 3D image processing system 1000. The memory device 400 may be implemented by a non-volatile memory device. The non-volatile memory device may include a plurality of non-volatile memory cells.

Each of the non-volatile memory cells may be implemented as an EEPROM (Electrically Erasable Programmable Read-Only Memory), a flash memory, a MRAM (Magnetic RAM), a MRAM (Spin-Transfer Torque MRAM), a conductive bridging RAM (CBRAM), a FeRAM (Ferroelectric RAM), a PRAM (Phase change RAM) called as a OUM (Ovonic Unified Memory), a Resistive RAM (RRAM or ReRAM), a Nanotube RRAM, a Polymer RAM (PoRAM), a Nano Floating Gate Memory (NFGM), a holographic memory, a Molecular Electronics Memory, or an Insulator Resistance Change Memory.

The inventive concepts can also be embodied as computer-readable codes on a computer-readable medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. Also, functional programs, codes, and code segments to accomplish the inventive concepts can be easily construed by programmers skilled in the art to which the inventive concepts pertain.

As described above, according to some embodiments of the inventive concepts, a 3D image signal processing method, a 3D ISP performing the method, and a 3D image processing system including the same increase the sensitivity of depth information using pixel binning without changing a filter array, thereby reducing noise.

While the inventive concepts have been particularly shown and described with reference to exemplary embodiments thereof, it will be understood by those of ordinary skill in the art that various changes in form and detail may be made therein without departing from the spirit and scope of the inventive concepts as defined by the following claims.

What is claimed is:

1. A three-dimensional (3D) image signal processing method comprising:
generating a first image based on color information and depth information obtained by a 3D image sensor;
obtaining a binning value by performing binning using a particular pixel among pixels for the depth information of the first image and pixels for the depth information that are adjacent the particular pixel; and
updating the depth information with the binning value and generating a second image by matching updated depth information with the color information.

2. The 3D image signal processing method of claim 1, wherein said generating the first image comprises separating the pixels for the depth information from pixels for the color information, and storing the pixels for the depth information.

3. The 3D image signal processing method of claim 2, wherein said obtaining the binning value comprises:
selecting the particular pixel from the pixels for the depth information of the first image and obtaining an average value using pixel values of the particular pixel and the adjacent pixels,
said updating the depth information including updating the pixel value of the particular pixel with the average value, and updating the depth information with respect to an entirety of the first image.

4. The 3D image signal processing method of claim 3, wherein said selecting the particular pixel and obtaining the average value comprises:
selecting the particular pixel from the pixels for the depth information of the first image;
deciding a weight for each of the particular pixel and the adjacent pixels; and
obtaining a weighted average using pixel values of the weighted pixels.

5. The 3D image signal processing method of claim 1, wherein said obtaining the binning value further comprises controlling the binning based on a value of the depth information of the first image.

6. The 3D image signal processing method of claim 2, wherein said obtaining the binning value further comprises controlling the binning based on a value of the depth information of the first image.

7. The 3D image signal processing method of claim 3, wherein said obtaining the binning value further comprises controlling the binning based on a value of the depth information of the first image.

8. The 3D image signal processing method of claim 4, wherein said obtaining the binning value further comprises controlling the binning based on a value of the depth information of the first image.

9. A non-transitory computer readable recording medium for storing a program for executing the 3D image signal processing method of claim 1.

10. A three-dimensional (3D) image signal processor comprising:
a first image generator configured to generate a first image based on color information and depth information obtained by a 3D image sensor; and
a pixel binning unit configured to perform binning using a particular pixel among pixels for the depth information of the first image and pixels for the depth information that are adjacent the particular pixel.

11. The 3D image signal processor of claim 10, further comprising a depth buffer configured to separate the pixels for the depth information from pixels for the color information and store the pixels for the depth information.

12. The 3D image signal processor of claim 11, wherein the pixel binning unit comprises:
a calculator configured to select the particular pixel of the first image from the depth buffer and calculate an average value using pixel values of the particular pixel and the adjacent pixels;
an updating block configured to update the pixel value of the particular pixel with the average value and update the depth information with respect to an entirety of the first image; and
a matching block configured to generate a second image by matching updated depth information with the color information.

13. The 3D image signal processor of claim 12, wherein the calculator decides a weight for each of the particular pixel and the adjacent pixels, applies the weight to each of the pixels, and calculates a weighted average.

14. The 3D image signal processor of claim 10, further comprising a controller configured to generate a control signal based on a value of the depth information of the first image to control an operation of the pixel binning unit.

15. A three-dimensional (3D) image processing system comprising the 3D image signal processor of claim 10.

16. A three-dimensional (3D) image processing system comprising:
an image sensor configured to generate color information and depth information of an object;
a first image generator configured to generate a first image based on the color information and the depth information; and
an image signal processor configured to separate from the first image pixels for depth information and pixels for color information, select a particular pixel in the first image from among the pixels for depth information, obtain an average pixel value of the particular pixel and pixels for the depth information in the first image that are adjacent the particular pixel, update the depth information of the particular pixel using the average pixel value, and generate and output a second image by matching the updated depth information with the color information.

17. The 3D image processing system of claim 16, wherein the image signal processor is further configured to determine a weight for each of the particular pixel and the adjacent pixels, and obtain a weighted average using pixel values of the weighted pixels for use as the average pixel value.
